(19) United States
(12) Patent Application Publication
(10) Pub. No.: US 2026/0158641 A1
(43) Pub. Date: Jun. 11, 2026

(54) WEARABLE ROBOT

(71) Applicants: Hyundai Motor Company, Seoul (KR); Kia Corporation, Seoul (KR)

(72) Inventors: Kyu Jung Kim, Hwaseong (KR); Ju Young Yoon, Hwaseong (KR); Beom Su Kim, Hwaseong (KR); Min Woong Jeung, Hwaseong (KR); Seong Taek Hwang, Hwaseong (KR); Jong Woo Kim, Hwaseong (KR); Ji Hwan Choi, Hwaseong (KR); Ye Young Kim, Hwaseong (KR); Hyun Seop Lim, Hwaseong (KR); Jong Kyu Choi, Hwaseong (KR)

(21) Appl. No.: 19/179,493

(22) Filed: Apr. 15, 2025

(30) Foreign Application Priority Data
Nov. 15, 2024 (KR) 10-2024-0162762

(51) Int. Cl. B25J 9/00; B25J 9/10

(52) U.S. Cl. CPC B25J 9/0006; B25J 9/10

(57) ABSTRACT

The provided robot features a waist-worn support part, a torque generator to assist arm movement, and an arm-wearable assembly. The arm section has a curved body region forming a space for the user's arm, plus an extension member that helps detach the torque generator from the waist mount. A housing and button region attach magnetically to a slot on the support, allowing quick engagement. A rail and band further secure the arm, while a switch member biased by an elastic element enables automatic release under certain conditions. The design offers stable arm support, easy attachment, and adjustable assistance for a range of activities.

### CROSS-REFERENCE TO RELATED APPLICATION

This application claims the benefit of Korean Patent Application No. 10-2024-0162762 filed in the Korean Intellectual Property Office on Nov. 15, 2024, the entire contents of which are incorporated herein by reference.

### BACKGROUND

### Technical Field

The present disclosure relates to a wearable robot, and more particularly, to a wearable robot capable of assisting muscular strength of a wearer.

### BACKGROUND

A wearable robot for assisting shoulder muscular strength, which is used to assist shoulder muscular strength of a wearer, is sometimes equipped with a component called a torque generator. An elastic body provided in the torque generator is deformed in shape while corresponding to a position of the wearer's arm in order to generate a restoring force. The restoring force is used to assist the wearer's shoulder muscular strength.

In existing technologies, because a wearable robot designed to assist shoulder muscular strength generates an upward rotational force, the wearer wears the wearable robot in a state in which the wearer raises his/her arm while the wearer wears the wearable robot. However, if the wearer does not wear the wearable robot with the correct posture, the torque generator can be pushed upward by the elastic force of the elastic body within the wearable robot, causing the wearable robot to unfold.

### SUMMARY

The present disclosure has been made to enable a wearer to wear a wearable robot even in a state in which the wearer lowers his/her arm, thereby improving wearability and safety of the wearable robot.

One example embodiment of the present disclosure provides a wearable robot including: a support part; a torque generator rotatably coupled to the support part; an arm wearable part coupled to one side of the torque generator; and an attachable part provided at one side of the torque generator, in which the attachable part is configured to be reversibly attached to or detached from the support part.

The attachable part may include: a housing region fixed to the torque generator; and a button region provided at one side of the housing region and configured to be rotatable relative to the housing region, and the button region may be reversibly attached to or detached from the support part.

The support part may include a slot region formed in a region to which the button region is attached, one of the button region and the slot region may include a magnet member, and the other of the button region and the slot region may contain a material attached to the magnet member.

The arm wearable part may include: an arm wearable body region configured to define a body of the arm wearable part and including a curved section configured to define an accommodation space in which a wearer's arm is accommodated; and an extension member at least partially extending along the curved section of the arm wearable part and having one side connected to the button region.

The extension member may be connected to the button region by means of the curved section of the arm wearable part and the housing region.

The extension member may include a bent portion between the curved section and a section extending from the curved section toward the housing region.

The attachable part may include a rail member fixed to one side of the torque generator, and the arm wearable body region may be coupled to be movable in a direction in which the rail member extends.

The extension member may be provided to pass over the rail member in the section extending from the curved section toward the housing region, and the extension member may be bent at a portion where the extension member passes over the rail member.

One side of the housing region may be fixedly coupled to the rail member.

The arm wearable part may further include a band member configured to connect one side end and the other side end of the arm wearable body region based on a direction in which the band member surrounds the wearer's arm, and one side of the extension member may be connected to the band member.

The support part may include a support part body configured to define a body of the support part, and the band member may be configured to surround the support part body and the arm wearable body region together.

The band member may be configured to surround a surface of the support part body opposite to a surface of the support part body that faces the arm wearable body region.

The attachable part may further include a fixing member provided at one side of the rail member and coupled to one end of the band member.

The arm wearable part may further include: an arm wearable body region configured to define a body of the arm wearable part and including a curved section configured to define an accommodation space in which a wearer's arm is accommodated; an extension member having one side fixed to the arm wearable part, and the other side connected to the button region; a switch member having one side rotatably coupled to the arm wearable body region, and the other side protruding from the arm wearable body region toward the accommodation space; and an elastic member provided between the arm wearable body region and the switch member.

One side of the extension member may be fixed to the switch member.

A distance between one side of the switch member and the button region may be shorter than a distance between the other side of the switch member and the button region.

In some embodiments, a wearable robot is provided. The wearable robot includes a support part configured to be worn about a waist of a wearer; a torque generator rotatably coupled to the support part and configured to provide assistive force for movement of the wearer's arm; an arm wearable part coupled to the torque generator and an attachable part provided at the torque generator and configured to be detachably attached to the support part,, The arm wearable part includes an arm wearable body region configured to define an accommodation space for the wearer's arm, and an extension member extending from the arm wearable body region toward the torque generator. The extension member is operable to urge the attachable part out of engagement with the support part when the wearer's arm is positioned in the accommodation space, thereby allowing the torque generator to move relative to the support part.

The attachable part may include a housing region fixed to the torque generator; and a button region rotatably provided at the housing region. The button region may be detachably received in a slot region formed at the support part, and a magnetic coupling may be provided between the slot region and the button region.

The arm wearable part may further include a rail member extending between the torque generator and the arm wearable body region, and a band member configured to surround both the support part and the am wearable body region when tightened.

The button region may be positioned to pass over the rail member along the extension member when the band member is tightened around the wearer's arm.

The wearable robot may further include a switch member pivotally coupled to the arm wearable body region and engaging the extension member, and an elastic member biasing the switch member toward a position in which the extension member urges the button region to detach from the slot region.

As discussed, the method and system suitably include use of a controller or processer.

According to the present disclosure, it is possible to enable the wearer to wear the wearable robot even in the state in which the wearer lowers his/her arm, thereby improving wearability and safety of the wearable robot.

### BRIEF DESCRIPTION OF THE DRAWINGS

FIG. 1 is a first perspective view of a wearable robot according to some embodiments of the present disclosure.

FIG. 2 is a second perspective view of the wearable robot according to some embodiments of the present disclosure.

FIG. 3 is an enlarged view illustrating a main part of the wearable robot according to some embodiments of the present disclosure.

FIG. 4 is a first horizontal cross-sectional view of the wearable robot according to some embodiments of the present disclosure in a state in which a button region is attached to a support part.

FIG. 5 is a second horizontal cross-sectional view of the wearable robot according to some embodiments of the present disclosure in a state in which the button region is spaced apart from the support part.

FIG. 6 is a horizontal cross-sectional view illustrating another example of the wearable robot according to some embodiments of the present disclosure.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “wearable robot” herein may refer to a mechanical or electromechanical device, often termed an exoskeleton, designed to be worn on the body to augment, assist, or enhance human physical movement.

The term “support part” herein may refer to a structure configured to be worn about the waist or torso region of a user, providing a stable base or anchor point for other robot assemblies.

The term “torque generator” herein may refer to a motor, actuator, or other force-producing mechanism configured to impart rotational movement or assistive force to a connected limb or joint of the wearable robot.

The term “arm wearable part” herein may refer to a portion of the wearable robot designed to fit around or along a wearer's arm to guide, support, or assist arm movements.

The term “extension member” herein may refer to a structural extension or linkage protruding from the arm wearable body region toward the torque generator, configured to provide mechanical interaction.

The term “attachable part” herein may refer to a sub-assembly, provided at the torque generator, that can be selectively and detachably coupled to support part to facilitate quick engagement or disengagement.

Hereinafter, a wearable robot according to the present disclosure will be described with reference to the drawings.

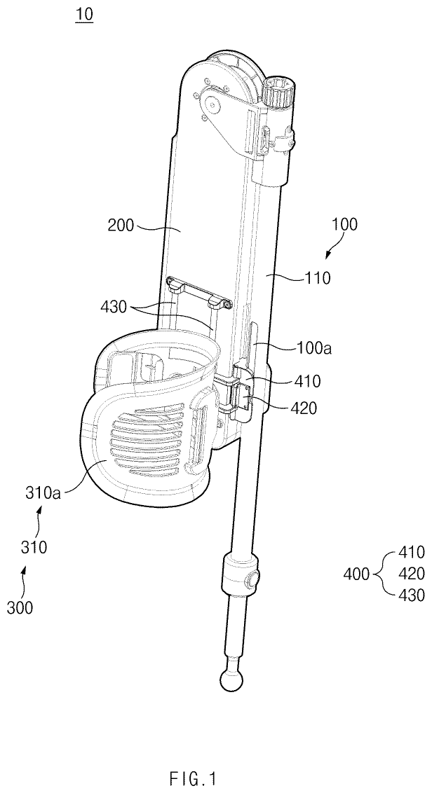

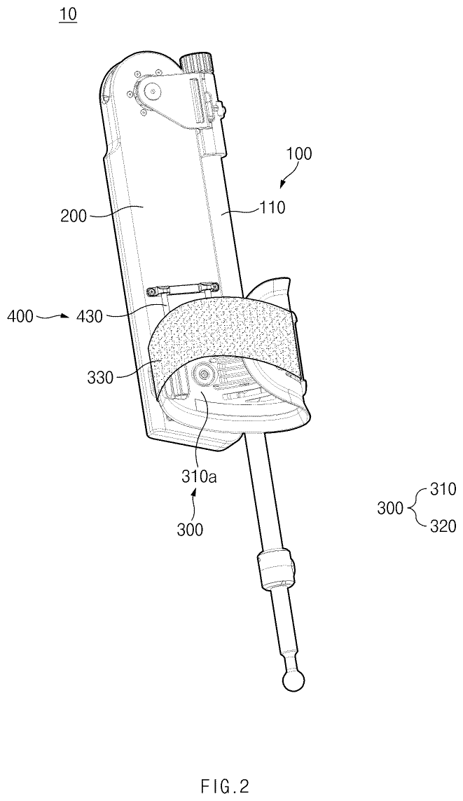

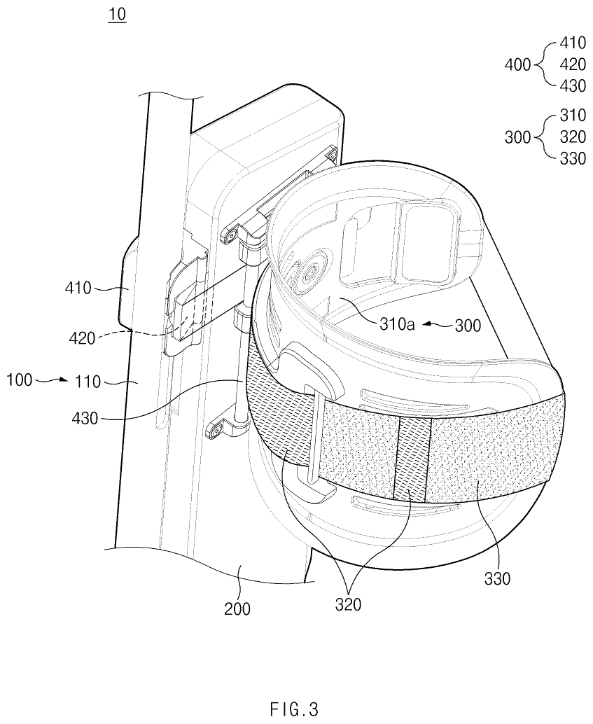

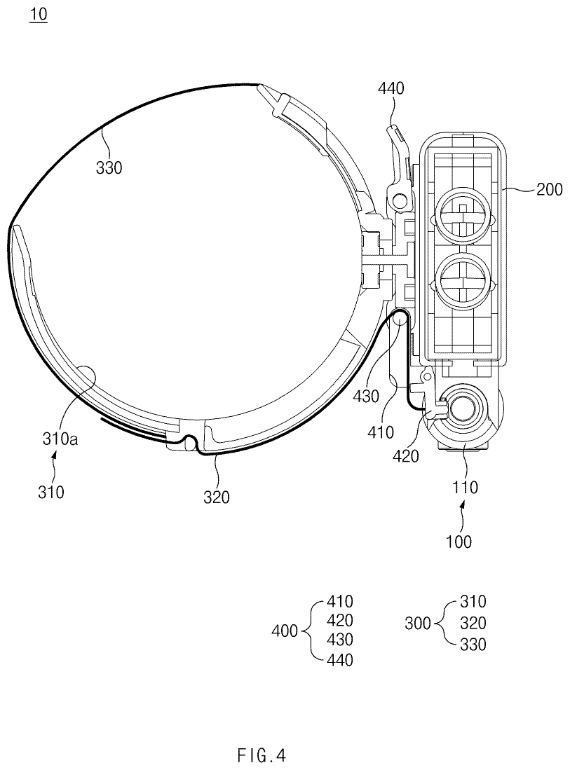

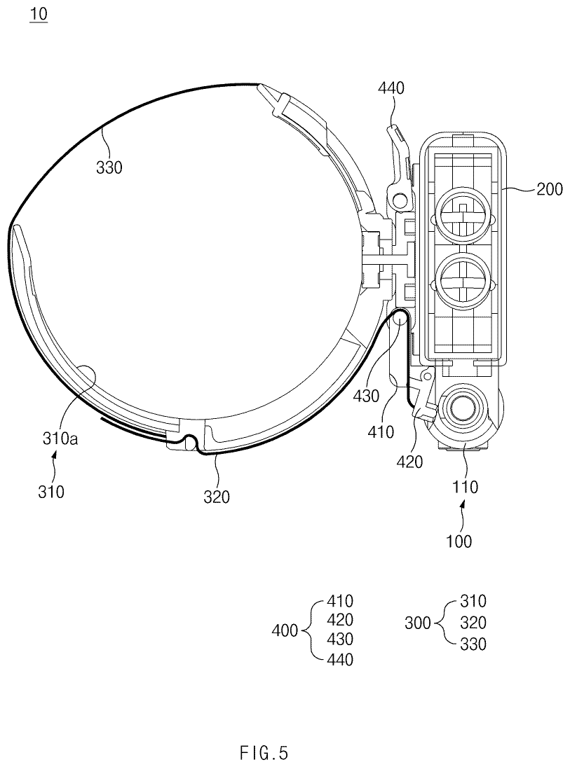

FIG. 1 is a first perspective view of a wearable robot according to the present disclosure, and FIG. 2 is a second perspective view of the wearable robot according to the present disclosure. FIG. 3 is an enlarged view illustrating a main part of the wearable robot according to the present disclosure, and FIG. 4 is a first horizontal cross-sectional view of the wearable robot according to the present disclosure in a state in which a button region is attached to a support part. FIG. 5 is a second horizontal cross-sectional view of the wearable robot according to the present disclosure in a state in which the button region is spaced apart from the support part.

With reference to FIGS. 1 to 5, a wearable robot 10 according to the present disclosure may include a support part 100, a torque generator 200 rotatably coupled to the support part 100, an arm wearable part 300 coupled to one side of the torque generator 200, and an attachable part 400 provided at one side of the torque generator 200.

The wearable robot 10 according to the present disclosure may be configured to generate assistive power for assisting muscular strength of a wearer. More specifically, the wearable robot 10 according to the present disclosure may be configured to generate assistive power for assisting shoulder muscular strength of the wearer.

For example, the support part 100 may serve to support the waist by being tightly attached to the wearer's waist. The torque generator 200 may generate a restoring force in accordance with a relative rotation angle of the support part 100, thereby generating assistive power for assisting shoulder muscular strength of the wearer. In addition, the arm wearable part 300 may be configured to surround the wearer's arm. The arm wearable part 300 may be configured to move in accordance with a motion of the wearer's arm to allow the torque generator 200 to rotate relative to the support part 100.

Meanwhile, according to the present disclosure, the attachable part 400 may be configured to allow the torque generator 200 to be fixed relative to the support part 100. More specifically, the attachable part 400 may be configured to allow the torque generator 200 to be fixed relative to the support part 100 during a process in which the wearer wears the wearable robot 10 according to the present disclosure, i.e., a process in which the wearer wears the arm wearable part 300 on his/her arm. According to some embodiments of the present disclosure, the attachable part 400 may be reversibly attached to or detached from the support part 100. That is, according to the present disclosure, the attachable part 400 is attached to the support part 100 during a process in which the wearer wears the wearable robot 10, such that the torque generator 200 may be fixed relative to the support part 100. After the wearer wears the wearable robot 10, the attachable part 400 may be separated from the support part 100, such that the torque generator 200 may generate the assistive power in accordance with the wearer's arm angle. Therefore, according to the present disclosure, the wearer may stably wear the wearable robot in a state in which the torque generator 200 is lowered downward instead of a state in which the torque generator 200 is moved upward from the support part 100.

Hereinafter, detailed configurations of the arm wearable part 300 and the attachable part 400 will be described in detail.

With reference to FIGS. 3 to 5, the attachable part 400 may include a housing region 410 fixed to the torque generator 200, and a button region 420 provided at one side of the housing region 410 and rotatably coupled to the housing region 410. For example, the housing region 410 may include a recessed region having a shape corresponding to the support part 100 to accommodate a part of the support part 100 (a part of a support part body to be described below).

For example, according to the present disclosure, the above-mentioned button region 420 may be reversibly attached to or detached from the support part 100. More specifically, according to the present disclosure, when the button region 420 is attached to the support part 100, the torque generator 200 may be relatively fixed to the support part 100. When the button region 420 is spaced apart from the support part 100, the torque generator 200 may be kept rotatable relative to the support part 100.

For example, the button region 420 and the support part 100 may be attached to each other by a magnetic force. More specifically, the support part 100 may include a slot region 100a formed in a region to which the button region 420 is attached. For example, one of the button region 420 and the slot region 100a may include a magnet member, and the other of the button region 420 and the slot region 100a may contain a material attachable to the magnet member. FIGS. 3 to 4 illustrate states in which the button region 420 contains or is made of a magnet member, and the slot region 100a has a shape recessed inward and extending in a direction in which the support part 100 extends (e.g., an upward/downward direction based on a state in which the wearer wears the wearable robot). FIG. 1 illustrates a state in which the button region 420 is attached to a lower section of the slot region 100a.

Meanwhile, the arm wearable part 300 may include an arm wearable body region 310 configured to define a body of the arm wearable part 300 and including a curved section 310a configured to define an accommodation space configured to accommodate the wearer's arm, and an extension member 320 at least partially extending along the curved section 310a of the arm wearable part 300 and having one side connected to the button region 420. For example, the extension member 320 may contain or be made of a wire member.

According to the present disclosure, the button region 420 may be separated from the support part 100 by pulling the extension member 320 in a state in which the button region 420 is attached to the support part 100. That is, after the wearer wears the wearable robot 10, the button region 420 needs to be separated from the support part 100 to allow the wearer to perform the operation in the state in which the wearer wears the wearable robot 10. For example, according to the present disclosure, the extension member 320 may be used to easily separate the button region 420 from the support part 100.

More specifically, as illustrated in FIGS. 3 to 5, the extension member 320 may be connected to the button region 420 by means of the housing region 410 and the curved section 310a of the arm wearable part 300. The extension member 320 may include a bent portion between the curved section 310a and a section extending from the curved section 310a toward the housing region 410.

Meanwhile, the support part 100 may include a support part body 110 configured to define a body of the support part 100. For example, the above-mentioned slot region 100a may be formed in a surface of the support part body 110. The support part body 110 may be configured to be tightly attached to the wearer's waist when the wearer wears the wearable robot 10.

Meanwhile, the wearable robot 10 according to the present disclosure may further include a means capable of changing a position of the arm wearable part 300 with respect to the support part 100 depending on the body type of the wearer. More specifically, the attachable part 400 may further include a rail member 430 fixed to one side of the torque generator 200. For example, the arm wearable body region 310 may be coupled to be movable in a direction in which the rail member 430 extends. That is, according to the present disclosure, the arm wearable body region 310 may slide along the rail member 430.

With continued reference to FIGS. 3 to 5, the extension member 320 may be configured to pass over the rail member 430 in the section extending from the curved section 310a toward the housing region. The extension member 320 may be bent at a portion where the extension member 320 passes over the rail member 430. More specifically, the extension member 320 may pass over the rail member 430 and be bent in a direction in which the extension member 320 surrounds the rail member 430, and then the extension member 320 may extend toward the button region 420. Meanwhile, one side of the housing region 410 may be fixedly coupled to the rail member 430. For example, the housing region 410 may be fixed to the housing region 410 by using the rail member 430 without a separate component for fixing the support part 100.

Meanwhile, the arm wearable part 300 may further include a band member 330 configured to connect one side end and the other side end of the arm wearable body region 310 based on a direction in which the band member 330 surrounds the wearer's arm. When the wearer's arm is positioned in the accommodation space defined by the arm wearable body region 310, the band member 330 may securely surround the wearer's arm so that the wearer's arm and the arm wearable part 300 are stably fixed. The band member 330 may be made of or contain a material with flexibility. More particularly, at least one of one side end and the other side end of the band member 330 may be detachably coupled to the arm wearable body region 310.

Meanwhile, according to the present disclosure, one side of the extension member 320 may be connected to the band member 330. For example, the extension member 320 may further include a Velcro member, and the above-mentioned Velcro member may be detachably coupled to the band member 330. Therefore, according to the present disclosure, when the portion (e.g., the Velcro member) of the extension member 320 connected to the band member 330 is pulled after the wearer completely wears the wearable robot 10, the button region 420 may be rotated and separated from the slot region 100a of the support part 100.

Meanwhile, according to the present disclosure, the band member 330 may stably fix the wearer's arm to the arm wearable part 300. The band member 330 may also accessorily serve to maintain the state in which the support part 100 and the torque generator 200 are fixed to each other when the wearable robot 10 is stored.

In order to exhibit the above-mentioned function, the wearable robot 10 according to the present disclosure may be configured such that the band member 330 may surround the support part body 110 and the arm wearable body region 310 together. It may be understood that the wearable robot 10 is provided with the configuration capable of stably maintaining the state in which the band member 330 surrounds the support part body 110 and the arm wearable body region 310 together. More particularly, the band member 330 may be configured to surround a surface of the support part body 110 opposite to a surface of the support part body 110 that faces the arm wearable body region 310.

For example, the attachable part 400 may further include a fixing member 440 provided at one side of the rail member 430 and coupled to one end of the band member 330. For example, the fixing member 440 may be a slide cam lock member. For example, the fixing member 440 may be provided to face the button region 420 with the rail member 430 interposed therebetween. The fixing member 440 may be fixedly coupled to the rail member 430.

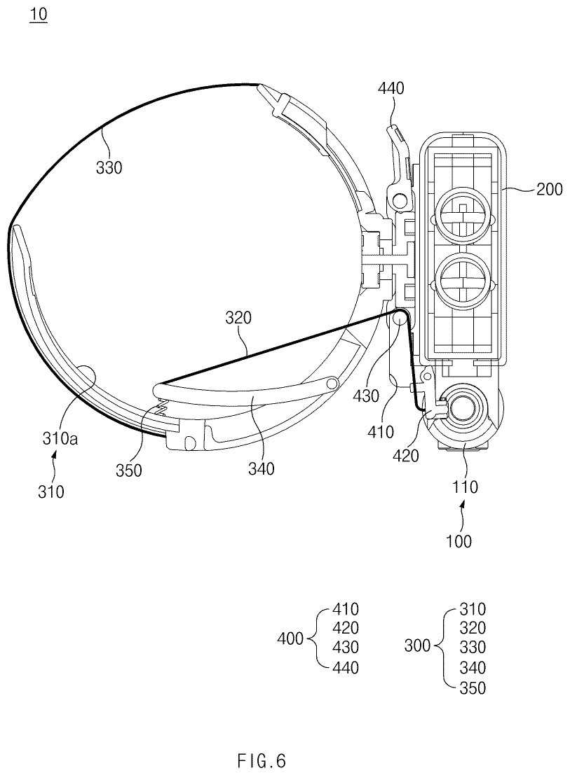

FIG. 6 is a horizontal cross-sectional view illustrating another example of the wearable robot according to the present disclosure.

The above-mentioned structure of the wearable robot 10, which has been described with reference to FIGS. 1 to 5, may be basically applied to the wearable robot 10 illustrated in FIG. 6 in an intact manner. However, as described below, the wearable robot 10 illustrated in FIG. 6 may further include a means for allowing the button region 420 to be automatically separated from the support part 100 in case that the wearer's arm is positioned in the accommodation space defined by the arm wearable body region 310.

More specifically, in addition to the arm wearable body region 310 and the extension member 320, the arm wearable part 300 may further include a switch member 340 having one side rotatably coupled to the arm wearable body region 310, and the other side protruding from the arm wearable body region 310 toward the accommodation space, and an elastic member 350 provided between the arm wearable body region 310 and the switch member 340. For example, one side of the extension member 320 may be fixed to the switch member 340. For example, FIG. 6 illustrates a state in which the elastic member 350 is provided to face a region in which the extension member 320 is fixed to the switch member 340.

As illustrated in FIG. 6, according to another example of the present disclosure, when the wearer's arm is accommodated in the arm wearable body region 310, the wearer's arm pushes the extension member 320 toward an inner surface of the arm wearable body region 310. Therefore, a tensile force is applied to the extension member 320 and pulls the button region 420, and the button region 420 is rotated, such that the button region 420 may be separated from the support part 100. Therefore, according to another example of the present disclosure, when the wearer performs the operation of wearing the wearable robot 10, the button region 420 and the support part 100 may be detached without a separate manipulation. In order to properly exhibit the above-mentioned function, the extension member 320 may include a portion configured to traverse the accommodation space from the switch member 340 in a state in which the wearer's arm is not positioned in the arm wearable body region 310. In addition, a distance between one side of the switch member 340 (i.e., a rotation center of the switch member) and the button region 420 may be shorter than a distance between the other side of the switch member 340 and the button region 420.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A wearable robot comprising:
a support part;
a torque generator rotatably coupled to the support part;
an arm wearable part coupled to the torque generator; and
an attachable part provided at the torque generator,
wherein the attachable part is configured to be detachably attached to the support part.

2. The wearable robot of claim 1, wherein the attachable part comprises:
a housing region fixed to the torque generator; and
a button region provided at the housing region and configured to be rotatable relative to the housing region and
wherein the button region is detachably attached to the support part.

3. The wearable robot of claim 2, wherein the support part comprises a slot region formed in a region to which the button region is attached,
wherein one of the button region and the slot region comprises a magnet member and
wherein the other of the button region and the slot region contains a material attached to the magnet member.

4. The wearable robot of claim 2, wherein the arm wearable part comprises:
an arm wearable body region configured to define a body of the arm wearable part and comprising a curved section configured to define an accommodation space in which a wearer's arm is accommodated; and
an extension member at least partially extending along the curved section of the arm wearable part and connected to the button region.

5. The wearable robot of claim 4, wherein the extension member is connected to the button region by means of the curved section of the arm wearable part and the housing region.

6. The wearable robot of claim 5, wherein the extension member comprises a bent portion between the curved section and a section extending from the curved section toward the housing region.

7. The wearable robot of claim 6, wherein the attachable part comprises a rail member fixed to the torque generator and
wherein the arm wearable body region is coupled to be movable in a direction in which the rail member extends.

8. The wearable robot of claim 7, wherein the extension member is provided to pass over the rail member in the section extending from the curved section toward the housing region, and the extension member is bent at a portion where the extension member passes over the rail member.

9. The wearable robot of claim 7, wherein the housing region is fixedly coupled to the rail member.

10. The wearable robot of claim 7, wherein the arm wearable part further comprises a band member configured to connect one side end and the other side end of the arm wearable body region based on a direction in which the band member surrounds the wearer's arm and
wherein the extension member is connected to the band member.

11. The wearable robot of claim 10, wherein the support part comprises a support part body configured to define a body of the support part and
wherein the band member is configured to surround the support part body and the arm wearable body region together.

12. The wearable robot of claim 11, wherein the band member is configured to surround a surface of the support part body opposite to a surface of the support part body that faces the arm wearable body region.

13. The wearable robot of claim 11, wherein the attachable part further comprises a fixing member provided at the rail member and coupled to one end of the band member.

14. The wearable robot of claim 2, wherein the arm wearable part further comprises:
an arm wearable body region configured to define a body of the arm wearable part and comprising a curved section configured to define an accommodation space in which a wearer's arm is accommodated;
an extension member having one side fixed to the arm wearable part, and the other side connected to the button region;
a switch member having one side rotatably coupled to the arm wearable body region, and the other side protruding from the arm wearable body region toward the accommodation space; and
an elastic member provided between the arm wearable body region and the switch member.

15. The wearable robot of claim 14, wherein the extension member is fixed to the switch member.

16. The wearable robot of claim 15, wherein a distance between one side of the switch member and the button region is shorter than a distance between the other side of the switch member and the button region.

17. A wearable robot comprising:
a support part configured to be worn about a waist of a wearer;
a torque generator rotatably coupled to the support part and configured to provide assistive force for movement of the wearer's arm;
an arm wearable part coupled to the torque generator, the arm wearable part comprising:
an arm wearable body region configured to define an accommodation space for the wearer's arm, and
an extension member extending from the arm wearable body region toward the torque generator; and
an attachable part provided at the torque generator and configured to be detachably attached to the support part,
wherein the extension member is operable to urge the attachable part out of engagement with the support part when the wearer's arm is positioned in the accommodation space, thereby allowing the torque generator to move relative to the support part.

18. The wearable robot of claim 17, wherein the attachable part comprises:
a housing region fixed to the torque generator; and
a button region rotatably provided at the housing region,
wherein the button region is detachably received in a slot region formed at the support part, and wherein a magnetic coupling is provided between the slot region and the button region.

19. The wearable robot of claim 18, wherein the arm wearable part further comprises:
a rail member extending between the torque generator and the arm wearable body region, and
a band member configured to surround both the support part and the am wearable body region when tightened,
wherein the button region is positioned to pass over the rail member along the extension member when the band member is tightened around the wearer's arm.

20. The wearable robot of claim 18, further comprising:
a switch member pivotally coupled to the arm wearable body region and engaging the extension member, and
an elastic member biasing the switch member toward a position in which the extension member urges the button region to detach from the slot region.
